(19) United States
(12) Patent Application Publication
(10) Pub. No.: US 2025/0348304 A1
(43) Pub. Date: Nov. 13, 2025

(54) SYSTEMS FOR AND METHODS OF USING A SECURE DATALOADER

(71) Applicant: ASTRONAUTICS CORPORATION OF AMERICA, Oak Creek, WI (US)

(72) Inventor: David JONES, Oak Creek, WI (US)

(21) Appl. No.: 18/862,263

(22) PCT Filed: May 9, 2023
(86) PCT No.: PCT/US2023/066771

§ 371 Date: Nov. 1, 2024

Related U.S. Application Data
(60) Provisional application No. 63/339,962, filed on May 9, 2022.

(51) Int. Cl. G06F 8/65

(52) U.S. Cl. CPC G06F 8/65

(57) ABSTRACT

Disclosed are systems, methods, and media for using a secure dataloading system for updating an aerospace system. The secure dataloading system includes a communications module that is configured to communicatively couple the secure dataloading system to the aerospace system. The secure dataloading system also includes a processor that is configured a to access a software repository storing a secure software update having a unique hash ID to provide a copy of the secure software update to the aerospace system via the communications module. The processor can be configured to use a blockchain to validate the unique hash ID of the software update and, upon validation of the unique hash ID, install the secure software update on the aerospace system.

### CROSS-REFERENCE TO RELATED APPLICATIONS

This patent application claims the benefit of U.S. Provisional Patent Application 63/339,962, filed on May 9, 2022, the entire contents of which is hereby incorporated by reference, for any and all purposes.

### STATEMENT REGARDING FEDERALLY SPONSORED RESEARCH

N/A

### BACKGROUND

The present disclosure relates generally to systems and methods for updating, managing, and maintaining aerospace systems. More specifically, the present disclosure relates to systems and methods for providing secure dataloading, for example, using blockchain technologies to securely update aerospace systems.

### SUMMARY

The present disclosure provides systems, methods, and media for securely accessing software packages and tracking transactions through a supply chain and within the careful constraints that are unique to aircraft. In accordance with one non-limiting example, a secure dataloading system may be used to communicate with a blockchain to securely access and a validate a software package using blockchain technology before installing the software package onto an aerospace system. Accordingly, the security of software packages can be enhanced and installation of compromised data on aerospace systems can be prevented, thus leading to increased safety of aerospace systems and all those associated with aerospace systems, such as pilots, crew members, passengers, ground control personnel, maintenance personnel, etc.

In accordance with one aspect of the disclosure, a dataloading system for updating an aerospace system is provided including a communications module that is configured to communicatively couple the dataloading system to the aerospace system and a processor that is configured to access a software repository storing a secure software package having a unique hash ID. The processor is further configured to provide a copy of the secure software package to the aerospace system via the communications module by using a blockchain to validate the unique hash ID of the secure software package and, only upon validation of the unique hash ID, installing the secure software package on the aerospace system.

In accordance with another aspect of the disclosure, a method is provided for updating an aerospace system. The method includes identifying a secure software package having a unique hash ID, coupling a dataloading system to the aerospace system to receive the secure software package, and accessing, by the dataloading system, a software repository to provide a copy of the secure software package to the aerospace system. The method further includes validating the unique hash ID for the secure software package using a blockchain, and upon validation of the unique hash ID, installing the secure software package on the aerospace system using the dataloading system.

In accordance with yet another aspect of the disclosure, a non-transitory computer-readable medium is provided containing software applications that, when executed, cause a dataloading system to perform operations. The operations include accessing a software repository to provide a copy of a secure software package to an aerospace system, validating a unique hash ID for the secure software package using a blockchain, and upon validation of the unique hash ID, installing the secure software package on the aerospace system using a dataloading device.

The foregoing and other aspects and advantages of the present disclosure will appear from the following description. In the description, reference is made to the accompanying drawings that form a part hereof, and in which there is shown by way of illustration one or more embodiment. These embodiments do not necessarily represent the full scope of the invention, however, and reference is therefore made to the claims and herein for interpreting the scope of the invention. Like reference numerals will be used to refer to like parts from Figure to Figure in the following description.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is an example of a conventional software supply chain in accordance with aspects of the present disclosure.

FIG. 2 is an example of an aerospace software supply chain using a secure dataloading system in accordance with aspects of the present disclosure.

FIG. 3 is another example of an aerospace software supply chain using a secure dataloading system in accordance with aspects of the present disclosure.

FIG. 4 is a block diagram of a blockchain communication network for a dataloading system in accordance with aspects of the present disclosure.

FIG. 5 is a block diagram of a recording module used in the dataloading system of FIG. 3 in accordance with aspects of the present disclosure.

FIG. 6 is an example schematic of a blockchain used to track and verify a software package in accordance with aspects of the present disclosure.

FIG. 7 is a flowchart of non-limiting example steps for a method of providing a software package across a supply chain using a blockchain in accordance with aspects of the present disclosure.

FIG. 8 is a flowchart of non-limiting example steps for a method of updating a blockchain in accordance with aspects of the present disclosure.

FIG. 9 is a flowchart of non-limiting example steps for a method of accessing a software package using a secure dataloading system in accordance with aspects of the present disclosure.

FIG. 10 is an example schematic of a method of securely accessing software using a secure dataloading system in accordance with aspects of the present disclosure.

### DESCRIPTION

Before any aspects of the disclosure are explained in detail, it is to be understood that the present disclosure is not limited in its application to the details of construction and the arrangement of components set forth in the following description or illustrated in the following drawings. The present disclosure is readily extended to other aspects and implementations and may be practiced or carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein in the context of computer implementation, unless otherwise specified or limited, the terms “component,” “system,” “module,” “controller,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In the methods described herein, the steps can be carried out in any order without departing from the principles of the disclosure, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “substantially” as used herein refers to a majority of, or mostly, as in at least about 50%, at least about 60%, at least about 70%, at least about 80%, at least about 90%, at least about 95%, at least about 96%, at least about 97%, at least about 98%, at least about 99%, at least about 99.5%, at least about 99.9%, at least about 99.99%, or at least about 99.999% or more.

The following discussion is presented to enable a person skilled in the art to make and use aspects of the disclosure. Various modifications to the illustrated configurations or processes will be readily apparent to those skilled in the art, and the generic principles herein can be applied to other aspects and applications within the scope of the present disclosure and the understanding of one of skill based thereon. Thus, the present disclosure is not intended to be limited to particular embodiments or aspects shown, but is to be accorded the widest scope consistent with the principles and features disclosed herein. The following detailed description is to be read with reference to the figures, in which like components or elements fin different figures have like reference numerals. The figures, which are not necessarily to scale, depict selected aspects and configurations or processes and are not intended to limit the scope of the disclosure. Skilled artisans will recognize the examples provided herein have many useful alternatives and fall within the scope of the disclosure.

In accordance with aspects of the present disclosure, mechanisms (which can, for example, include systems, methods, and media) for securely accessing software packages and tracking transactions through a supply chain and within the careful constraints that are unique to aircraft are provided. The use of loadable software parts (LSPs) in aerospace systems (i.e., aircraft or spacecraft systems) has grown dramatically in recent years which has greatly expanded the capabilities of aerospace systems. As a result, most, if not all, of current aerospace systems rely on software to function and communicate with other systems in a network, including systems on aircraft and ground or control systems. Correspondingly, communication between members of aerospace systems is critical to their function. In the case of commercial aircraft systems, complex supply chains are utilized to maintain aerospace systems. Supply chain networks provide aerospace systems with vital information, such as software, which is used to ensure compliance with the latest safety regulations and optimize system performance. Software that is used in aerospace systems is subject to frequent updates to ensure aerospace systems are utilizing the latest information and systems available. For example, software updates on commercial transport category aircraft are mandated by some laws to occur regularly at least every 28 days. Accordingly, software is a necessary component of avionic systems, and the integrity of aerospace software must be secured to provide safe execution of complex electronics guiding and operating civil aircraft. As complex electronics are ubiquitous on aerospace systems and such systems increasingly foregoing the use of mechanical backups, it is imperative that risks due to tampered software be mitigated to maintain aviation safety in aerospace systems around the globe.

However, conventional aerospace systems typically rely upon complex supply chain networks that can put vital software at risk of being interfered with. Specifically, the lifecycle environment of software in aviation can be elaborate, and software may pass through many intermediate steps and take alternative paths before reaches the ultimate destination of being installed on an aerospace system. For example, software may initially be provided by a supplier and subsequently shipped, for example, to many different suppliers, developers, manufacturers, communication networks, maintenance and operation networks, or any combination thereof. Software can further be transferred along the supply chain before reaching installation on an aircraft.

Due to the large number of transfer points along a typical software supply chain, software can become vulnerable to malicious interference, (i.e., cyberattacks) which may compromise the software. This in turn can have cascading deleterious effects on an aerospace system which may pose risks to customer safety and decrease the number of serviceable aircraft in a fleet. Additionally, it can be extremely difficult to determine the point along the supply chain at which that software is tampered with due to the complex organization of aerospace supply chains. This is particularly the case when older systems (e.g., legacy systems) are used in combination with newer systems Therefore, there is a need for dataloading systems and methods which provide enhanced security and cyber protection throughout a software supply chain for an aerospace system. Further, there is a need for dataloading systems that maintain a detailed transaction history across both new and legacy supply chain systems to further protect software updates or data packages from being compromised

Generally, the present disclosure provides systems, methods, and media for using a secure dataloading device that can advantageously access and validate a software package that travels through a supply chain for an aerospace system. In particular, aspects of the present disclosure provide systems, methods and media for recording a transactional history for a data or software package across a supply chain.

In some non-limiting examples, a dataloading system may be configured as a dataloading device. In one non-limiting example, the dataloading device can be coupled to a blockchain to securely access and validate a software package. Further, a blockchain may be used across a supply chain to encrypt a software package and record a decentralized transactional history associated with the software package. For example, a blockchain can be used to store a digital signature or unique hash ID associated with a software package, and the unique hash ID can be updated each time the software package is accessed, archived, or modified. Correspondingly, the dataloading device can use the blockchain to validate the chain of custody and data of the software package to confirm that the software package has not been the target of tampering. To that end, the dataloading device can be used to ensure that only verified software packages are installed on aerospace systems, thus decreasing the risk that comprised software or malware will interfere with aerospace systems. Accordingly, an advantage of the present disclosure is that the use of a secure dataloading device in accordance with the present disclosure can enhance the safety of aerospace systems and all those associated with aerospace systems, such as pilots, crew members, passengers, ground control personnel, maintenance personnel, etc.

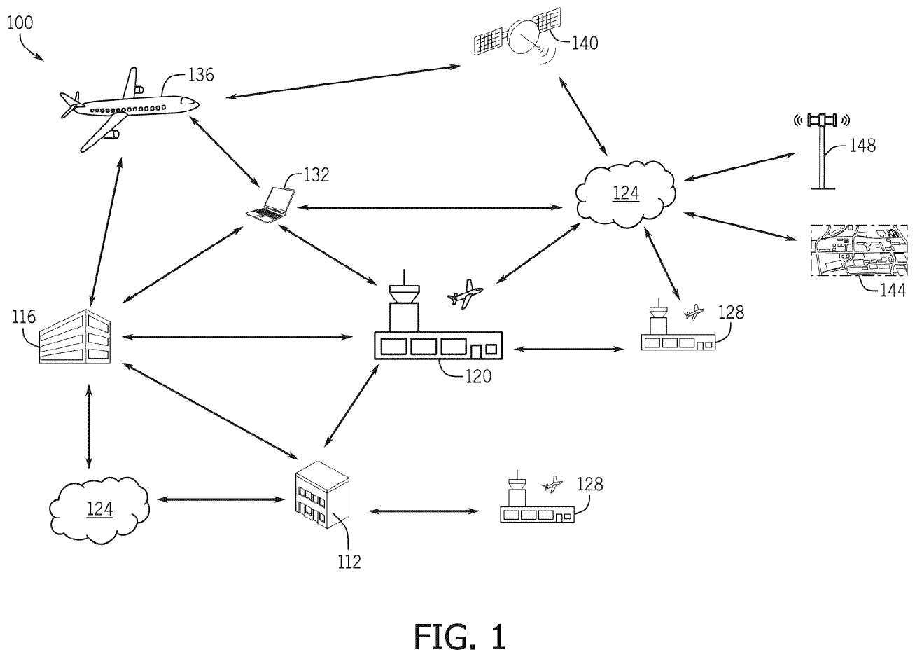

FIG. 1 illustrates an example of a conventional supply chain network for an aerospace system. As discussed above, update data, such as software or hardware, can be passed between many intermediate parties before finally being installed on an aerospace system. Correspondingly, a supply chain (e.g., a supply chain 100) for an aerospace system can include many different members and interconnected pathways therebetween. In the non-limiting example illustrated in FIG. 1, the supply chain 100 can be used to provide software and hardware to many different members in the supply chain 100. In particular, a supplier 112 can provide the software to one or more of an airframer 116, an airline 120, the internet 124, and a maintenance, repair, and operation (MRO) system 128. In some aspects, the airframer 116 can provide the software to one or more of the airline 120, the internet 124, a dataloading device 132, an aerospace system 136 (e.g., an aerospace system onboard an aircraft), or back to the supplier 112. In addition, the airline 120 can provide the software to one or more of the airframe 116, the internet 124, the MRO system 128, the dataloading device 132, and the aerospace system 136. The software can further be provided by the internet 124 to one or more of the supplier 112, the airframer 116, the airline 120, the MRO system 128, the dataloading device 132, a satellite system 140, a software service system 144 (e.g., a navigation software system), and a communication array system 148. In some aspects, the MRO system 128 can provide the software to one or more of the supplier 112, the airline 120, and the internet 124. In some aspects, the dataloading device 132 can provide the software to one or more of the airframer 116, the airline 120, the internet 124, and the aerospace system 136. Correspondingly, the aerospace system 136 can be in communication with one or more of the airframer 116, the dataloading device 132, and the satellite system 140 to receive or transfer the software. In some aspects, the satellite system 140 can provide the software to the internet 124 and the aerospace system 136, and the software service system 144 and the communication array system 148 can each provide the software to the internet 124.

Thus, the software can be provided to different members of the supply chain 100 in a variety of ways and along several different routes. It will be understood that the supply chain 100 described above is a non-limiting example of a supply chain for an aerospace system and that other parties may also exist in a supply chain for an aerospace system. In this way, there can exist a large number of transfer points along a software supply chain for an aerospace system, and communication may be unorganized or inefficient in large scale supply chain networks. As a result, conventional software supply chains can become convoluted which may leave such supply chains vulnerable to malicious interference.

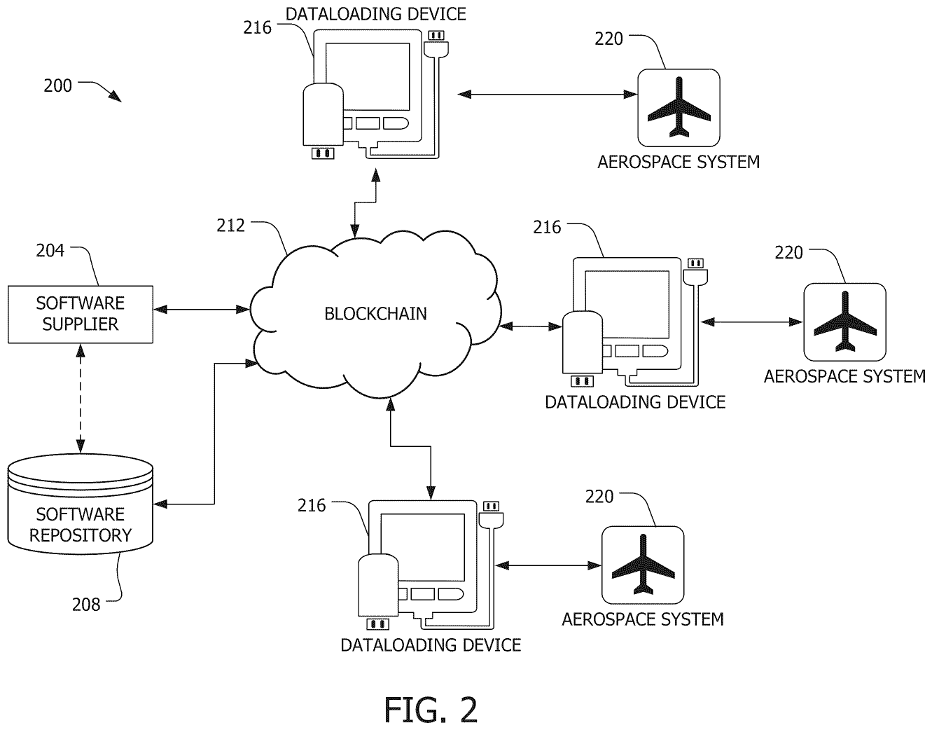

Referring now to the non-limiting example illustrated in FIG. 2, a supply chain (e.g., a secure supply chain 200) for an aerospace system can be simplified and safeguarded against malicious interference using a secure dataloading device in accordance with the present disclosure, which may be connected to or in communication with a blockchain. As will be described in greater detail below, a secure dataloading device can be a dataloading device that utilizes a blockchain or blockchain technology to securely access a software package. A software supplier can be in communication with a blockchain, and one or more dataloading devices can be in communication with a blockchain and one or more aerospace systems. In this way, a software supplier may not be in direct communication with a dataloading device or an aerospace system. Advantageously, a blockchain can be used to archive, access, and validate a software package to reduce the number of transfer points at different points in a supply chain. Instead, software can be archived in a particular location after being accessed by any member of a supply chain, and software can be validated using the blockchain in order to ensure software does not become compromised. Accordingly, a software package can include an additional layer of security by using a dataloading device in communication with a blockchain to archive and validate the software.

For example, a supply chain 200 can include a software supplier 204, a software repository 208, a blockchain 212, one or more dataloading devices 216, and one or more aerospace systems 220. The software supplier 204 can be in communication with the blockchain 212, and the one or more dataloading devices 216 can be in communication with the blockchain 212 and the one or more aerospace systems 220. In some aspects, the software repository 208 is in communication with the blockchain 212 and optionally in communication with the software supplier 204. In some aspects, the one or more aerospace systems 220 may also be in communication with the blockchain 212. As will be discussed below in greater detail, the software supplier 204 can provide (e.g., ship, transport through physical or digital means, transmit, etc.) a software package to be archived in the software repository 208. The blockchain 212 can be updated accordingly to record information related to the software package that may be archived, and the one or more dataloading devices 216 can be configured to access the software package from the software repository 208 by validating the software using the blockchain 212. After the one or more dataloading devices 216 has validated the software package using the blockchain 212, the one or more dataloading devices 216 can upload or install the software package onto the one or more aerospace systems 220. In this way, the blockchain 212 can provide an extra layer of security for the software package and facilitate indirect communication between the software supplier 204 and the one or more dataloading devices 216, thus simplifying flow of the software package through the supply chain 200.

In some aspects, the software supplier 204 can be any individual, group of individuals, or organization from which the software package originates or is developed. In the illustrated non-limiting example, the software supplier 204 can include any number of intermediary parties or third parties that come into contact with the software package before it is accessed and installed by the one or more dataloading devices 216. In some aspects, the software supplier 204 can produce the software package and include identification information therein such as a unique hash ID as will be discussed below in greater detail. After producing the software package, the software supplier 204 can store or archive the software package in the software repository 208. The software supplier 204 may be able to access the software package after it has been archived in the software repository 208 by interfacing with the blockchain 212, or the software supplier 204 can interface directly with the software repository 208. To interface with the blockchain, the software supplier can include a communications module as will be discussed below in greater detail.

In some aspects, a software repository can be configured to store any suitable type of software or data related to software. A software repository can be arranged as a dedicated storage system, such as a dedicated cloud network system or a dedicated software server. However, it is contemplated that a software repository may also be arranged as a decentralized storage system and can itself be stored on a blockchain. Additionally, a software repository can include information organized using any of a variety of suitable technique or combination of techniques. For example, the software repository 208 can be organized as a relational database, or a non-relational database. In some aspects, the software repository 208 can receive identifying information (e.g., package data) associated with a software package and can store the identifying information in connection with metadata related to the software package. For example, and as described below in greater detail, a software package can be associated with a unique hash ID encoded with identifying information (e.g., timestamp, source location, current storage location, etc.), and the software supplier 204 or the blockchain 212 can transmit the unique hash ID to the software repository 208 and archive the unique hash ID and the software package.

As another example, a software repository can store information about software packages that have been accessed or archived by a software supplier or a third party, and metadata related to the software packages. Additionally, in some aspects, a software repository can store information about software packages that have been accessed and installed by a dataloading device, and metadata related to the software packages. For example, the software repository 208 can store information and metadata related to the software package that is archived by the software supplier 204 and accessed by a third party or the one or more dataloading devices 216 using the blockchain 212. This data may be configured as transaction data and can updated at each instance in which the software package is archived or accessed. Accordingly, a detailed transaction history of the software package can be recorded in the software repository.

In some aspects, transactional data related to a software package can include information associated with modification or alteration of the software package which may be indicative of malicious interference. In this way, the status of the software package can be tracked as the software package is accessed by different members of the supply chain 200. However, it is contemplated that the software package can also be modified during normal operation of the supply chain 200 (e.g., intentional and approved modifications made by a third-party developer) and that data related to expected modifications can be compared with data related to actual modifications made to the software package to determine if the software package has been maliciously interfered with. In some aspects, the software repository 208 can be arranged as a dedicated storage system, such as cloud storage system or a dedicated server. However, it is also contemplated that the software repository 208 can be incorporated within the blockchain 212, meaning that all data stored in the software repository 208 is also reflected on the blockchain 212.

A blockchain (e.g., the blockchain 212) can be used to archive and update a software update or identification information thereof in an encrypted and distributed record. A blockchain can be a public blockchain technology, although it is contemplated that a blockchain can alternatively be a private blockchain technology that is used by a large entity such as an airline industry or state military. In any arrangement, a blockchain can be used to structure data (e.g., software data, transactional data, etc.) into chunks that are chained together, with each block being given an exact timestamp when added to the chain. It is contemplated that any of a variety of data may be suitable for storage or use on a blockchain, such as information related to price, date, location, quality, certification, transactions, metadata, and other relevant information. Advantageously, a blockchain can include a distributed record of transactions related to a software update, which can be maintained across various computing devices in a network or supply chain. For example, the blockchain 212 can be connected or coupled to the software supplier 204, the software repository 208, the one or more dataloading devices 216, or any combination thereof. In this way, the software supplier 204, the software repository 208, and the one or more dataloading devices 216 each define nodes of the blockchain 212. Put another way, copies of the blockchain 212 can be included on each node so that a record of the transactions related to the software package are stored on or are accessible by each of the software supplier 204, the software repository 208, and the one or more dataloading devices 216. In some aspects, and as discussed above, the blockchain can also define the software repository, meaning that a software package and data related thereto can be stored on the blockchain.

One or more dataloaders or dataloading devices can be arranged as a dataloader system to access, validate, and install a software package using a blockchain. A dataloader system can be any of a variety of combinations of software and hardware that is configured to connect to an aerospace system and load or install data thereon. Put another way, a dataloader or dataloading device can be a computing device that is capable of accessing, validating, and loading a data package onto a target system, such as an aerospace system. In some aspects, a dataloading device can be an onboard dataloader (e.g., an STC airborne dataloader), a portable dataloader, a shop loader device, or any combination thereof. In addition, a dataloading device can be arranged as a serial dataloader that can be configured to run industry standard protocols. For example, a dataloading device can be configured to run RS232/RS422 protocols, ARINC 615 protocols, ARINC 615A protocols, or any combination thereof. Advantageously, a dataloading device can include cyber security protocols that include the use of digital signatures and verification of digital signatures. In some aspects, a digital signature can be a unique hash ID which can be used to verify a data package (e.g., a software package) using a blockchain. Correspondingly, and as will be discussed in greater detail below, a dataloading device can include software applications or instructions that when executed can cause a dataloading device to access a software repository, validate a unique hash ID of a software package using a blockchain technology, and install a validated software package on an aerospace system.

Still referring to the non-limiting example illustrated in FIG. 2, the one or more dataloading devices 216 can be arranged as a dataloading system capable of accessing a software package stored on the software repository 208 using the blockchain 212 and installing the software package onto the one or more aerospace systems 220. In particular, the one or more dataloading devices 216 can be onboard dataloaders, portable dataloaders, serial dataloaders, or any combination thereof which can be configured to run RS232/RS422 protocols, ARINC 615 protocols, ARINC 615A protocols, or any combination thereof. In some aspects, the one or more dataloading devices 216 can include software applications or instructions that when executed can cause the one or more dataloading devices 216 to perform the operations of accessing the software repository 208, validating a unique hash ID of the software package through the blockchain 212 as discussed above, and installing the validated software package on the one or more aerospace systems 220. In some aspects, the one or more dataloading devices 216 may only load and install the software package after it has been validated, meaning that the software package may not be installed if it is determined to have been maliciously interfered with.

In some aspects, an aerospace system can be any of a variety of system that is used onboard an aircraft, by an airline, or by a ground control operation. In particular, an aerospace system can be any system that is used to within the aerospace environment and/or to acquire and/or share data between aircraft, maintenance crews, air traffic controllers, pilots, and passengers during operation of an aircraft. An aerospace system can be any combination of software and hardware within this context. In some aspects, the one or more aerospace systems 220 can include hardware and software that are used to ensure the aerospace systems 220 are in compliance with the latest safety guidelines and have access to the latest software. For example, the one or more aerospace systems 220 can include the one or more dataloading devices 216 as discussed above. Thus, the one or more aerospace systems 220 can be indirectly coupled or connected to different members in the supply chain 200.

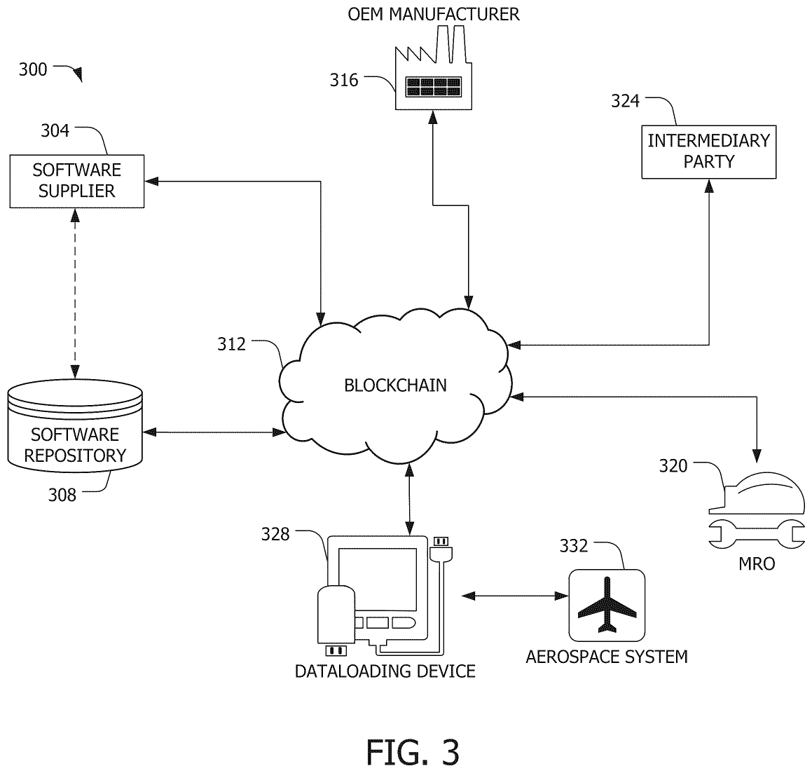

Relatedly, a supply chain can include additional members that may come into contact with a software package before it is finally installed on an aerospace system. In the illustrated non-limiting example illustrated in FIG. 3, a secure supply chain 300 can include a software supplier 304, a software repository 308, a blockchain 312, an original equipment manufacturer (OEM) 316, an MRO system 320, one or more intermediary parties 324, a secure dataloading device 328, and an aerospace system 332. In some aspects, each of the software supplier 304, the software repository 308, the blockchain 312, the OEM 316, the MRO system 320, the one or more intermediary parties 324, and the secure dataloading device 328 can be configured to indirectly communicate with one another through the blockchain 312, thereby providing an added layer of security to the software package. In particular, the blockchain 312 can keep a detailed ledger or history of each transaction (e.g., archiving or accessing the software package) by each of the members in the secure supply chain 300. Accordingly, the transaction history can be verified using the blockchain 312 before being installed in the aerospace system 332 by the secure dataloading device 328. However, in some aspects, it is contemplated that the software supplier 304 can optionally be in direct communication with the software repository 308, meaning that the software supplier 304 can directly archive the software update in the software repository 308.

It will be apparent to one of skill in the art that the above description is an example of a software supply chain for an aerospace system, and that a supply chain may contain additional or fewer members than those described above.

A dataloading device and a member of a supply chain that is downstream of the dataloading device (e.g., a software supplier, an OEM, an MRO system, one or more intermediary parties, etc.) can include software programs or instructions that are configured to direct the functions thereof. In some aspects, a member of a supply that is downstream of a dataloading device can define a downstream server. In some aspects, a downstream server can be in communication with a software repository and a blockchain, and a dataloading device can be in communication with a blockchain and an aerospace system. In particular, a dataloading device and a downstream server can each include hardware components that can be used to establish communication across a supply chain using a blockchain. Put another way, a blockchain communication network can be established between a dataloading device and a downstream server across which a software package can be provided. In some non-limiting aspects, a software package can be a package of data related to a software update for an aerospace system. It is contemplated that the software package can be configured as any type of suitable data, such as cloud network data, electronic data, data stored on physical media, or another type of data as discussed below.

In some aspects, a software package can be communicated over any suitable supply chain communication network using a blockchain, such as a Wi-Fi network (which can include one or more wireless routers, one or more switches, and the like), a peer-to-peer network (e.g., a Bluetooth network), a cellular network (e.g., a 3G network, a 4G network, a 5G network, etc., complying with any suitable standard(s), such as CDMA, GSM, LTE, LTE Advanced, WiMAX, 5G NR, etc.), a wired network, a local area network (LAN), a wide area network (WAN), a public network (e.g., the Internet, which may be part of a WAN and/or LAN), a private or semi-private network (e.g., a corporate or university intranet), any other suitable type of network, or any suitable combination of networks.

Correspondingly, techniques used to secure a software package using a blockchain as discussed herein can also be compatible with any other suitable technique or combination of techniques. Specifically, a software package transmitted across a supply chain can further be encrypted using any suitable technique or combination of techniques. For example, a software package can be encrypted using a blockchain technology and based on or more of Transport Layer Security (TLS) protocols, Secure Sockets Layer (SSL) protocols, or Internet Protocol Security (IPsec) protocols. As another example, a virtual private network (VPN) connection can be established between a downstream server and a dataloading device. As yet another example, a downstream server and a dataloading device can be used to limit access to a supply chain network, meaning that a supply chain network can be required to provide credentials (e.g., a username, a password, a hardware-based security token, a software-based security token, a one-time code, any other suitable credentials, or any suitable combination of credentials).

In some aspects, a downstream server and a dataloading device can each include any of a variety of suitable hardware, firmware, and/or software for communicating a software package over a supply chain network. For example, the downstream server and the dataloading device can each include one or more transceivers, one or more communication chips and/or chip sets, and the like that can be used to establish a Wi-Fi connection, a Bluetooth connection, a cellular connection, an Ethernet connection, and the like.

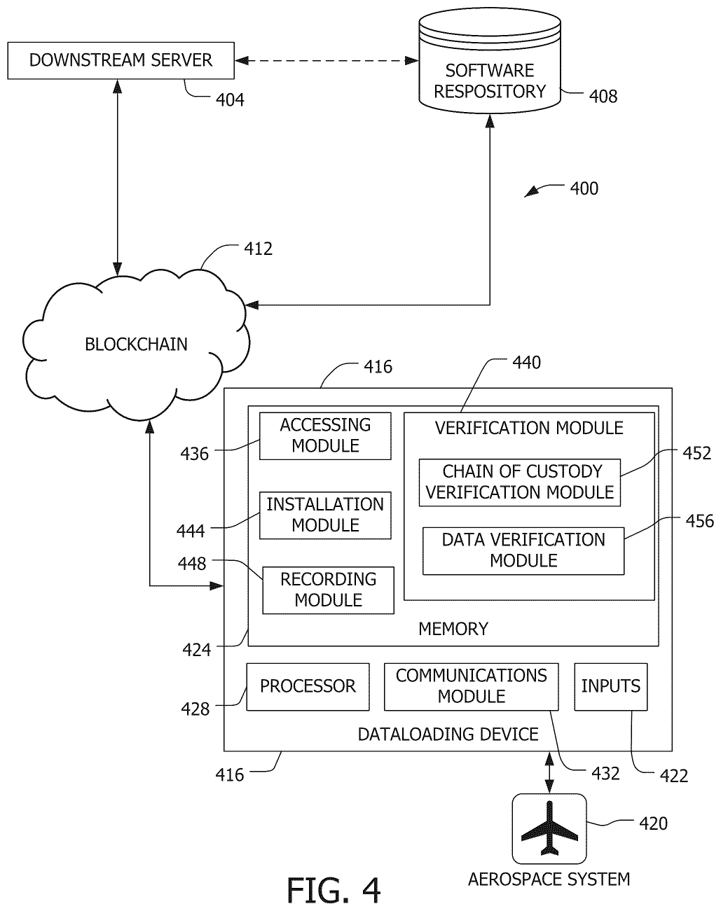

Referring now to FIG. 4, a block diagram is illustrated of an example supply chain network 400 that includes a downstream server 404, a software repository 408, a blockchain 412, a dataloading device 416, and an aerospace system 420. In some aspects, the downstream server 404 can be in communication with the blockchain 412 and optionally the software repository 408 while the dataloading device 416 can be in communication with the blockchain 412 and the aerospace system 420. In some aspects, the dataloading device 416 can include one or more inputs 422, a memory 424, a processor 428, and a communications module 432. In some aspects, the processor 428 can be any of a variety of suitable hardware processor or combination of processors, such as a central processing unit (CPU), a graphics processing unit (GPU), an accelerated processing unit (APU), etc. In some aspects, the inputs 422 can include any suitable input devices and/or sensors that can be used to receive user input, such as a keyboard, a mouse, a touchscreen, a graphic user interface (GUI), etc.

In some aspects, the memory 424 can include any suitable storage device or devices that can be used to store instructions, values, and the like, that can be used, for example, by the processor 428 to communicate with the blockchain 412 and the aerospace system 420. Specifically, the memory can include a communications module 432 that can be executed by the processor 428 to couple (i.e., place in communication with) the dataloading device 416 to the blockchain 412 and the aerospace system 420. The memory 424 can include any suitable volatile memory, non-volatile memory, storage, or any suitable combination thereof. For example, the memory 424 can include RAM, ROM, EEPROM, one or more flash drives, one or more hard disks, one or more solid state drives, one or more optical drives, and the like.

In some aspects, the memory 424 can have encoded thereon one or more computer programs or modules stored in the memory 424 for controlling operation of the dataloading device 416. Specifically, the processor 428 can be configured to execute one or more modules stored in the memory 424 to access a software update archived on the software repository 408, verify the software update, and install the validated software update on the aerospace system 420. For example, the processor 428 can execute an accessing module 436 to access the software repository 408 and obtain a copy of a software update, a verification module 440 to verify a unique hash ID associated with the software update, and an installation module 444 to install the verified software update onto the aerospace system 420. Additionally, the processor can execute a recording module 448 that records instances of accessing, verifying, and installing the software update as will be discussed below in greater detail.

In some aspects, the verification module 440 can include a chain of custody verification module 452 and a data verification module 456. The chain of custody verification module 452 can be executed by the processor 428 to verify chain of custody metadata that corresponds to the software package and that can be stored on the blockchain 412 (e.g., chain of custody metadata that is associated with the unique hash ID of the software package). The chain of custody metadata can include transactional data as discussed above, meaning that the chain of custody verification module 452 can determine who has accessed or archived the software package along the supply chain network 400 before finally being accessed by the dataloading device 416. Accordingly the chain of custody verification module 452 can be used to detect if any unauthorized entities have accessed the software package which may be indicative of malicious interference. Correspondingly, the data verification module 456 can be executed by the processor to verify that the data included in the software package (e.g., a software update for an aerospace system) is correct, meaning that the software package has not been tampered with.

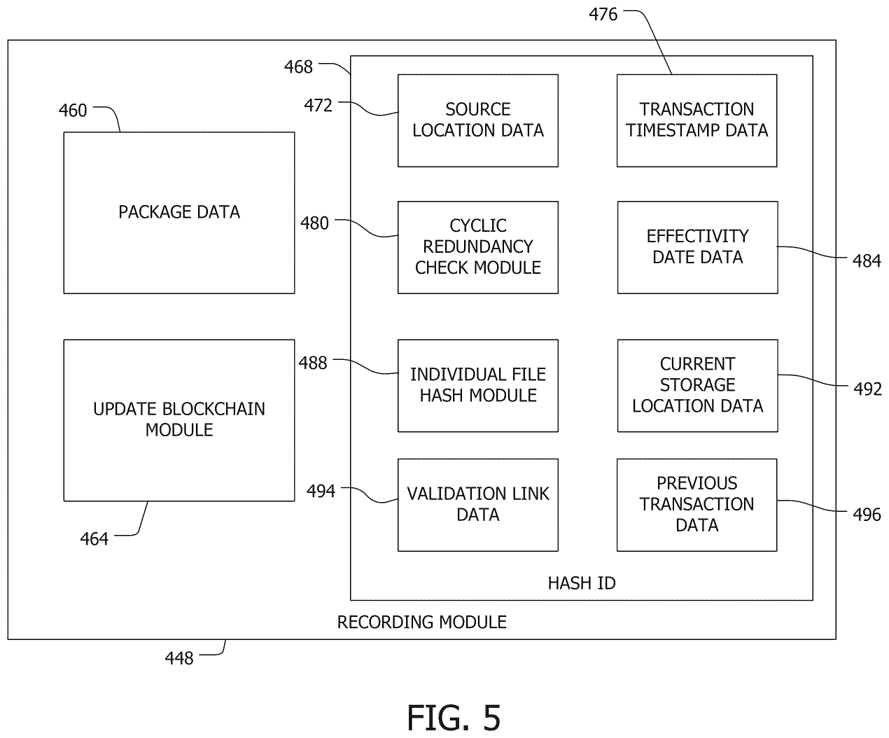

Referring now to the non-limiting example illustrated in FIG. 5, the recording module can include information about data included in the software package (e.g., identifying information and metadata) and a software application or module that updates the blockchain when executed. For example, the recording module 448 that includes at least package data 460, an update blockchain module 464, and a hash ID 468. In some aspects, the package data 460 can be the actual software update data that will be installed on the aerospace system 420 (see FIG. 4). As discussed above, a hash ID can be a sequence of alphanumeric characters that is unique to the software package and can be updated to record each transaction. Put another way, a unique hash ID can be modified each time a software package is accessed, archived, or installed. In this way, it can be possible to determine when a software package was last modified. Additionally, a unique hash ID can further include several different programs, modules, and/or categories of data associated with the software package or transactions involving the software package.

For example, the hash ID 468 can include at least source location data 472, transaction timestamp data 476, a cyclic redundancy check module 480, effectivity date data 484, an individual file hash module 488, current storage location data 492, a validation link 494, and previous transaction data 496. The source location data 472 can provide identify a source from which the software update originated (i.e., a point of origin of the software package such as a software supplier). The transaction timestamp data 476 can identify a date, time, and/or location from which the secure software update is accessed, validated, and/or installed. When executed by the processor 428 (see FIG. 4), the cyclic redundancy check module 480 can be configured to detect accidental or unexpected errors in the package data 460 to ensure that the integrity of the package data 460 has not been compromised. The effectivity date data 484 can identify a date or date range in which the software package can be accessed by a user. In some aspects, effectivity dates can be different for different members in a software supply chain for an aerospace system. When executed by the processor 428 (see FIG. 4), the individual file hash module 488 can be configured to provide a unique hash ID to each file included in the software package which in turn can further enhance security of the software package and package data 460. The current storage location data 492 can provide information on the current storage location of the software update, such as a location in the software repository 408, on the blockchain 412, or on the aerospace system 420 (e.g., an aircraft ID on the aerospace system 420) (see FIG. 4). The validation link 494 can be a link to the validation of the hash ID 468 of the software update on the blockchain 412 (see FIG. 4). Put another way, the validation link 494 can be a link to a block on the blockchain 412 (see FIG. 4) in which the software package was validated. In some aspects, the previous transaction data 496 can identify the most recent transaction associated with the software package or the comprehensive transactional history thereof. In this way, each transaction along a supply chain involving the software package can be recorded.

The update blockchain module 464 can be executed by the processor 428 (see FIG. 4) to create a new block that can be added or linked to a blockchain. In some aspects, the update blockchain module 464 can be executed by the processor 428 without any user interaction since a blockchain can be a decentralized network, meaning that each member of a supply chain can frequency broadcast and record transactions. A new block can include any identifying information as described above, such as the different modules and data categories included in the hash ID 468 and the package data 460. In this way, a blockchain can be updated to include a new block identifying that a new transaction has occurred, and the new block can include identifying information or metadata associated with the new transaction. As discussed above, the new block can be distributed to each member along a supply chain such that copies of the transaction can be available to any member of the supply chain, thus enhancing transaction clarity through the supply chain which in turn can increase the security of the software package. However, it is contemplated that specific transactions may only be available to particular members along the supply chain for privacy reasons. In some aspects, the

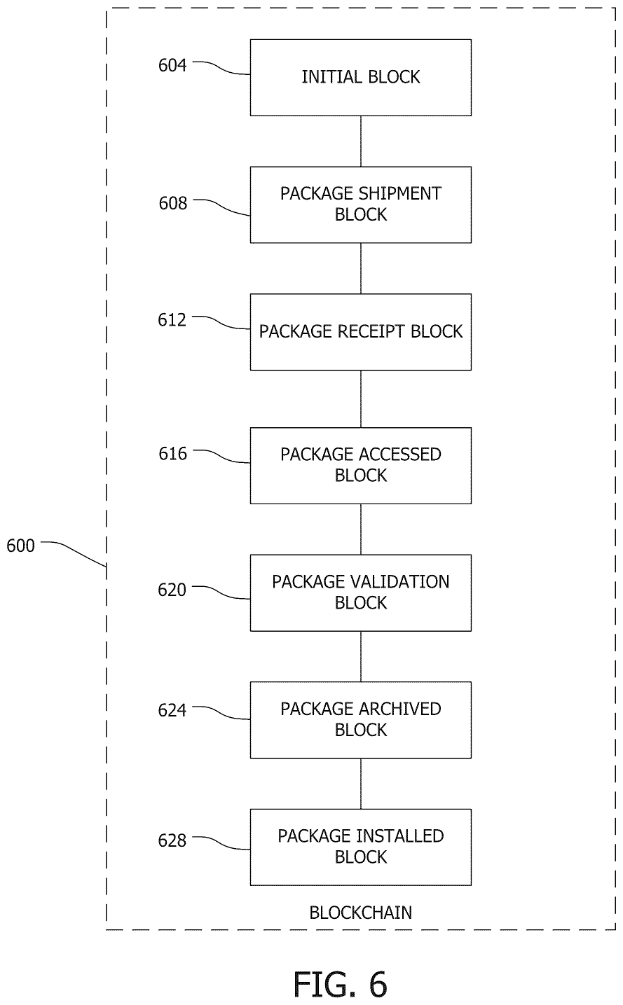

Correspondingly, and as discussed above, a blockchain can include any number of blocks that are linked to one another. In particular, a blockchain can include blocks that identify transactions associated with a software package being accessed, archived, and/or installed by different members of the supply chain. It is contemplated the blockchain can be arranged in any suitable configuration for recording transactional information and optionally storing a software package thereon. In the non-limiting example illustrated in FIG. 6, a blockchain 600 can include several different blocks detailing a transactional history of a software package as it is provided along a supply chain. Specifically, the blockchain 600 can include an initial block 604 that can may be created by a software supplier or a software repository when the software package is initially created or archived. A package shipment block 608 can be created at each instance in which a software packaged is shipped or sent from one member of the supply chain to another. Relatedly, a package receipt block 612 can be created at each instance in which a software packaged is received by a member of the supply chain. A package accessed block 616 can be created at each instance in which a software package is accessed by a member of the supply chain. A package validation block 620 can be created at each instance in which a software package is validated or verified by a member of the supply chain. A package archived block 624 can be created at each instance in which a software package is archived or stored, such as instances in which the software package is archived on a software repository or the blockchain 600. A package installed block 628 can be created at each instance in which a software package is loaded and installed onto an aerospace system. It is contemplated that a blockchain can include additional or fewer blocks than those described above, and that any number of copies of any block can be stored on a blockchain. Further, it is contemplated that the blocks and transactions described above may be associated with any member of a supply chain for an aerospace systems, such as one or more of a software supplier, a software repository, an OEM, an MRO system, an intermediary party, and a dataloading device.

There are several advantages of coupling a dataloading device to a blockchain in a software supply chain for an aerospace system. In particular, and as discussed above, using a blockchain to archive and access a software update for an aerospace system provides a decentralized transaction record to each member of a supply chain which in turn improves privacy while enhancing security throughout the supply chain. The decentralized transaction record can be used by a dataloading device to ensure that a software package has not been maliciously interfered with along the supply chain, thereby maintaining the integrity of the software package along the supply chain. Thus, by validating a software package throughout a supply chain using a decentralized blockchain network, only secure software packages can be selected for installation on an aerospace system. Accordingly, the safety of pilots, passengers, ground crew, and other personnel associated with aerospace systems can be improved.

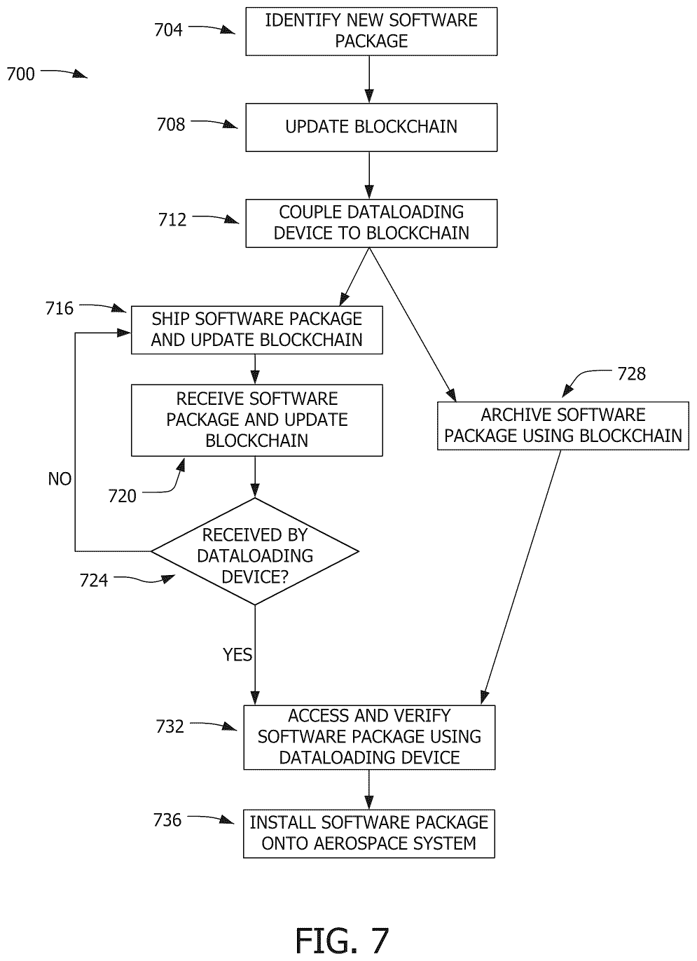

FIG. 7 illustrates a non-limiting example of a process for providing a software package across a supply chain using a blockchain in accordance with some aspects of the present disclosure. Specifically, the process 700 can be used to access, archive, validate, and install a software package. The process can include identifying a new software package (e.g., a secure software update) at 704 and updating the blockchain at step 708 with a new block to record and identify the new software package. At 712, the process 700 can include coupling a dataloading device or dataloader system to an aerospace system as described above. At 716, the process 700 can include shipping the software, meaning that a software package can be shipped or archived by a member of the supply chain. Correspondingly, the process 700 can include receiving the software package and updating the blockchain to confirm receipt of the software update at step 720.

In some aspects, the process 700 can include determining if the software update has been received by a dataloading device (e.g., a dataloading device that is included in an airline) at step 724. If the software package has not been received by the dataloading device, the process 700 can repeat steps 716 and 720 of shipping and receiving the software update, respectively, until the software package has received the software package. For example, a software package may be shipped by a software supplier or an OEM to an MRO system or an intermediary party before the software package is shipped to the dataloading device. Thus, it can be necessary to repeat steps 716 and 720 of shipping and receiving the software update to ensure that the software package is received by the dataloading device after being shipped between other members of the supply chain. Accordingly, multiple receipts chain of the software update corresponding to different members of the supply can be confirmed using the blockchain (e.g., a first receipt, a second receipt, a third receipt etc.) Alternatively, and as discussed above, the process 700 can include archiving the software package in a software repository at step 728 where it can be accessible by one or more members of the supply chain. In this way, it may not be necessary to directly ship the software package between members in the supply chain. Rather, a software package can be archived in a software repository using a blockchain to distribute copies of the software package to each member, and the blockchain can also distribute copies of any updates or modifications made to the software package to each member in the supply chain.

In some aspects, the process 700 can include accessing and validating the software package using a dataloading at step 732. As discussed above, validating the software package can include validating a unique hash ID associated with the software package. The process 700 can further include loading or installing the software package on an aerospace system using the dataloading device at step 736. It is contemplated that a blockchain can be updated to record any of the above steps or transactions to provide a comprehensive transaction record associated with the software package along the supply chain.

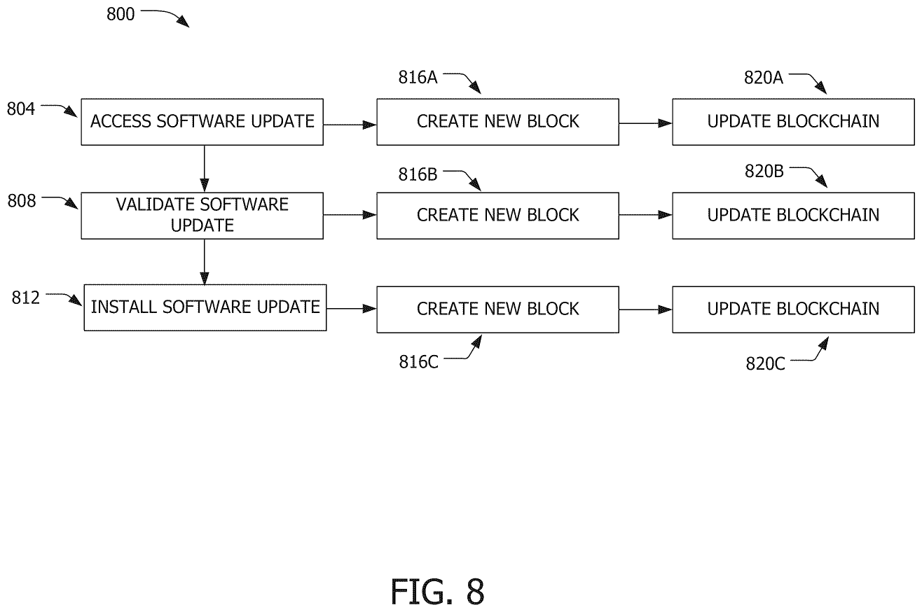

Specifically referencing the non-limiting example illustrated in FIG. 8, a blockchain can be updated at each instance in which a software update is accessed, validated, or installed. For example, a process 800 for updating a blockchain can include accessing a software package at step 804, validating the software package at step 808, and installing the software update at step 812. Executing each of the steps 804, 808, 812 can subsequently trigger creation of a new block at steps 816A, 816B, 816C. As discussed above, a new block can include identification information for the software update, such as metadata, source location data, transaction timestamp data, package data, effectivity date data, validation link data, current storage location data, previous transaction data, or any combination thereof. Further, each new block created at steps 816 can be added to the blockchain at steps 820A, 820B, 820C, respectively, to effectively update the blockchain. In this way, the identification information for the software update as described above can be updated to reflect the current status of the software update.

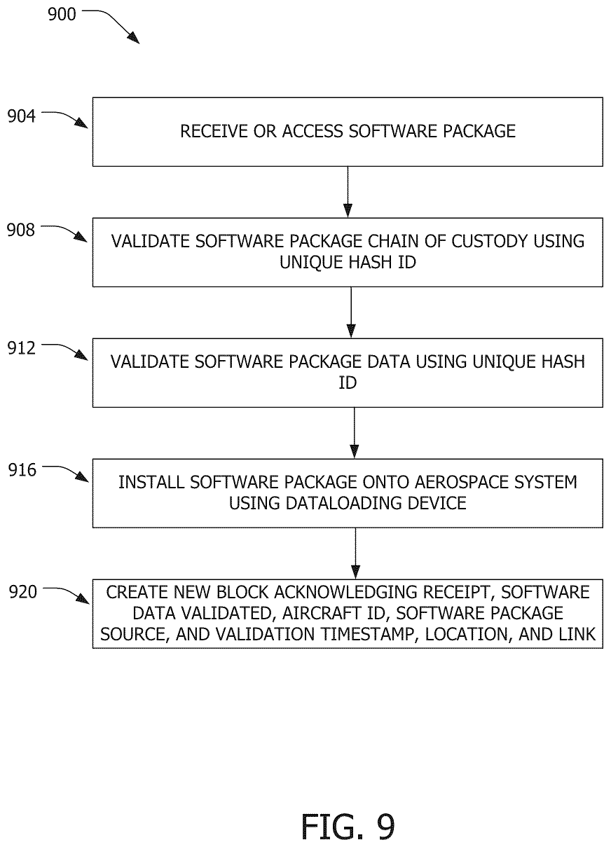

FIG. 9 illustrates a non-limiting example of a process for accessing a software package using a secure dataloading device in accordance with some aspects of the present disclosure. In particular, a process 900 can include receiving or accessing a software package (e.g., a copy of a software package distributed by a blockchain) at step 904 by the secure dataloading device. The secure dataloading device can access the software update using any suitable technique, such as retrieving a block in a blockchain that is associated with a software package that is stored on a software repository. At step 908, the process 900 can include validating the software package chain of custody using a unique hash ID associated with the software package. As discussed above, the unique hash ID can include a variety of identifying information or metadata associated with the software package, including a chain of custody or transactional record. By validating the chain of custody, the secure dataloading device can ensure that he software package being accessed has not been maliciously interfered with by an unauthorized party. Correspondingly, the process 900 can include validating the package data of the software package at step 912 to confirm that the software package has not been maliciously interfered with or compromised. After the software package has been validated, the process 900 can include loading or installing the software package onto an aerospace system at step 916 via the secure dataloading device. Accordingly, only software packages that have been validated are installed onto the aerospace system, thus preventing compromised data from being introduced to the aerospace system. In some aspects, the process 900 can include creating a new block for updating the blockchain at step 920 to acknowledge that the software update has been securely accessed, validated, and uploaded using the secure dataloading device. As discussed above, the new block can include identification information or metadata related to the software package, and copies of this information can be distributed to all members in a supply chain using the blockchain.

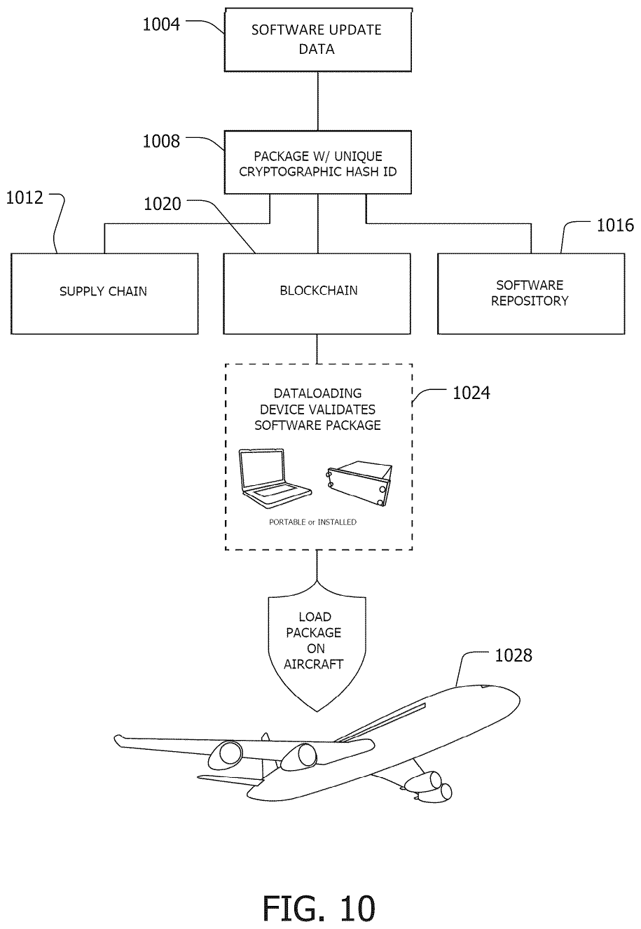

FIG. 10 illustrates a non-limiting example schematic of the process of providing a software package to a dataloading device and uploading the software package to an aerospace system. In particular, software data 1004 can be formatted into a software package 1008 associated with a unique hash ID (e.g., a cryptographic hash). The software package 1008 can then be supplied to a supply chain 1012, archived on a software repository 1016 (e.g., a cloud network), or both. Additionally, the unique hash ID can be stored or copied onto a blockchain 1020, although it is also contemplated that the software package 1008 can be directly stored onto the blockchain 1020 in some aspects. A dataloading device 1024 can access and validate the software package 1008 by interfacing with the blockchain 1020, and the dataloading device 1024 can be a portable dataloader or a dataloader that is installed on an aerospace system (e.g., a dataloader that is installed on an aircraft). Finally, the dataloading device 1024 can load or install the software package 1008 on an aerospace system or an aircraft 1028. In this way, a software package can be securely installed on an aerospace system using a secure dataloading device.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

As used in the claims, the phrase “at least one of A, B, and C” means at least one of A, at least one of B, and/or at least one of C, or any one of A, B, or C or combination of A, B, or C. A, B, and C are elements of a list, and A, B, and C may be anything contained in the Specification.

1. A dataloading system for updating an aerospace system, the dataloading system comprising:
a communications module configured to communicatively couple the dataloading system to the aerospace system; and
a processor configured to access a software repository storing a secure software package having a unique hash ID to provide a copy of the secure software package to the aerospace system via the communications module by:
using a blockchain to validate the unique hash ID of the secure software package, and only upon validation of the unique hash ID, installing the secure software package on the aerospace system.

2. The dataloading system of claim 1, wherein the unique hash ID of the secure software package includes:
a cyclic redundancy check for each file in the secure software package;
a unique secondary hash ID for each file in the secure software package;
software effectivity dates for the secure software package; and
a current storage location of the secure software package.

3. The dataloading system of claim 1, wherein the dataloading system creates a new block when using the blockchain, and wherein the new block includes identification information for:
the secure software package that was accessed and validated;
a source from which the secure software package originated;
a date, a time, or a location from which the secure software package is accessed and validated;
a link to the validation of the unique hash ID of the secure software package on the blockchain; and
a current storage location of the secure software package.

4. The dataloading system of claim 3, wherein the new block further includes identification information for shipping and receipt of the secure software package by an original equipment manufacturer or an airline.

5. The dataloading system of claim 4, wherein the secure software package is provided as electronic data, data stored on physical media, or cloud network data.

6. The dataloading system of claim 1, wherein the dataloading system includes an onboard dataloader, a portable dataloader, or both.

7. The dataloading system of claim 1, wherein the software repository is a cloud storage system or a dedicated software server.

8. The dataloading system of claim 1, wherein the dataloading system includes software applications that, when executed, perform the operations of:
creating a block in the blockchain;
accessing and validating the secure software package; and
installing the secure software package on the aerospace system.

9. A method of updating an aerospace system, the method comprising:
identifying a secure software package having a unique hash ID;
coupling a dataloading system to the aerospace system to receive the secure software package;
accessing, by the dataloading system, a software repository to provide a copy of the secure software package to the aerospace system;
validating the unique hash ID for the secure software package using a blockchain; and
upon validation of the unique hash ID, installing the secure software package on the aerospace system using the dataloading system.

10. The method of claim 9, wherein creating the unique hash ID for the secure software package includes:
creating a cyclic redundancy check for each file in the secure software package;
creating a unique secondary hash ID for each file in the secure software package;
creating software effectivity dates for the secure software package; and
updating a current storage location of the secure software package.

11. The method of claim 9, wherein using the blockchain comprises creating a new block that includes identification information for:
the secure software package that is accessed and validated;
a source from which the secure software package originated;
a date, a time, or a location from which the secure software package is accessed and validated;
a link to the validation of the unique hash ID for the secure software package on the blockchain; and
a current storage location of the secure software package.

12. The method of claim 9, the method further comprising:
shipping the secure software package to an original equipment manufacturer or an airline;
determining if the secure software package has been received by the airline;
upon determining that the secure software package has not been received by the airline, shipping the secure software package from the original equipment manufacturer to the airline; and
upon determining that the secure software package has been received by the airline, confirming a first receipt of the secure software package by the airline using the blockchain.

13. The method of claim 12, wherein shipping the secure software package to the original equipment manufacturer or the airline includes electronically shipping the secure software package, physically shipping the secure software package using a media, or uploading the secure software package to a cloud network.

14. The method of claim 13, the method further comprising:
archiving the secure software package in the software repository;
distributing the secure software package to a third party or maintenance personnel; and
confirming a second receipt of the secure software package by the third party or the maintenance personnel using the blockchain.

15. The method of claim 9, wherein validating the unique hash ID for the secure software package is performed by the dataloading system and includes validating a chain of custody of the secure software package using the blockchain and the dataloading system.

16. The method of claim 9, wherein the dataloading system includes an onboard dataloader or a portable dataloader.

17. The method of claim 9, wherein the software repository is a cloud storage system or a dedicated software server.

18. The method of claim 9, wherein the dataloading system includes software applications that, when executed, perform the operations of:
creating an initial block in the blockchain;
accessing and validating the secure software package; and
installing the secure software package on the aerospace system.

19. A non-transitory computer-readable medium containing software applications that, when executed, cause a dataloading system to perform the operations of:
accessing a software repository to provide a copy of a secure software package to an aerospace system;
validating a unique hash ID for the secure software package using a blockchain; and
upon validation of the unique hash ID, installing the secure software package on the aerospace system using a dataloading device.

20. The non-transitory computer-readable medium of claim 19, wherein using the blockchain comprises creating a new block that includes identification information for:
the secure software package that is accessed and validated;
a source from which the secure software package originated;
a date, a time, or a location from which the secure software package was accessed and validated;
a link to the validation of the unique hash ID for the secure software package on the blockchain; and
a current storage location of the secure software package.
